(19) United States
(12) Patent Application Publication
(10) Pub. No.: US 2003/0010799 A1
(43) Pub. Date: Jan. 16, 2003

(54) Electronic device attachment mechanism

(76) Inventors: Rene Ashing, Brooklyn, NY (US); James Smith, Brooklyn, NY (US)

Correspondence Address: Richard W. Goldstein, 2071 Clove Road, Staten Island, NY, 10304, US

(21) Appl. No.: 09/901,774

(22) Filed: Jul. 10, 2001

(51) Int. Cl. B60R 7/06

(52) U.S. Cl. 224/483; 224/901.8

(57) ABSTRACT

An electronic device attachment mechanism including a first attachment adapted for securement to a piece of furniture or a car dashboard. A second attachment is adapted for securement to an electronic device. The second attachment is adapted for removable coupling with the first attachment.

### BACKGROUND OF THE INVENTION

The present invention relates to an electronic device attachment mechanism and more particularly pertains to allowing a electronic device to be removably attached to a piece of furniture or car dashboard to prevent it from becoming lost.

The use of electronic devices and accessories is known in the prior art. More specifically, electronic devices and accessories heretofore devised and utilized for the purpose of preserving electronic devices are known to consist basically of familiar, expected and obvious structural configurations, notwithstanding the myriad of designs encompassed by the crowded prior art which have been developed for the fulfillment of countless objectives and requirements.

By way of example, U.S. Pat. No. 5,370,241 to Silvers discloses a remote control fitted with a hook and loop fastener strip on the back for attachment to a matching strip on a holder assembly to prevent the device from becoming misplaced. U.S. Pat. No. 5,872,702 to Kopel discloses a remote control holder device using releasable fastening strips for mounting. U.S. Pat. No. 5,598,143 to Wentz discloses a remote control locating device with a pile type fastener on the signal box and the beeper.

While these devices fulfill their respective, particular objective and requirements, the aforementioned patents do not describe an electronic device attachment mechanism for allowing an electronic device to be removably attached to a piece of furniture or car dashboard to prevent it from becoming lost.

In this respect, the electronic device attachment mechanism according to the present invention substantially departs from the conventional concepts and designs of the prior art, and in doing so provides an apparatus primarily developed for the purpose of allowing an electronic device to be removably attached to a piece of furniture or car dashboard to prevent it from becoming lost.

Therefore, it can be appreciated that there exists a continuing need for a new and improved electronic device attachment mechanism which can be used for allowing an electronic device to be removably attached to a piece of furniture or car dashboard to prevent it from becoming lost. In this regard, the present invention substantially fulfills this need.

### SUMMARY OF THE INVENTION

In the view of the foregoing disadvantages inherent in the known types of electronic devices and accessories now present in the prior art, the present invention provides an improved electronic device attachment mechanism. As such, the general purpose of the present invention, which will be described subsequently in greater detail, is to provide a new and improved electronic device attachment mechanism which has all the advantages of the prior art and none of the disadvantages.

To attain this, the present invention essentially comprises a first attachment adapted for securement to a piece of furniture or car dashboard. The first attachment includes a generally rectangular base member having an upper surface and a lower surface. The lower surface has an adhesive disposed thereon for securement to a specified piece of furniture or car dashboard. The upper surface has a plurality of attachment bristles extending outwardly therefrom. Each of the bristles include an elongated stem having a ball secured to an outer end thereof. A second attachment is adapted for securement to an electronic device. The second attachment is adapted for removable coupling with the first attachment. The second attachment includes a generally rectangular base member having an upper surface and a lower surface. The lower surface has an adhesive disposed thereon for securement to the electronic device. The upper surface has a plurality of attachment bristles extending outwardly therefrom. Each of the bristles include an elongated stem having a ball secured to an outer end thereof. The plurality of attachment bristles of the second attachment engage the plurality of bristles of the first attachment for removably coupling the electronic device to the piece of furniture or car dashboard. There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved electronic device attachment mechanism which has all the advantages of the prior art electronic devices and accessories and none of the disadvantages.

It is another object of the present invention to provide a new and improved electronic device attachment mechanism which may be easily and efficiently manufactured and marketed.

It is a further object of the present invention to provide a new and improved electronic device attachment mechanism which is of durable and reliable construction.

An even further object of the present invention is to provide a new and improved electronic device attachment mechanism which is susceptible of a low cost of manufacture with regard to both materials and labor, and which accordingly is then susceptible of low prices of sale to the consuming public, thereby making such an electronic device attachment mechanism economically available to the buying public.

Even still another object of the present invention is to provide a new and improved electronic device attachment mechanism for allowing an electronic device to be removably attached to a piece of furniture or car dashboard to prevent it from becoming lost.

Lastly, it is an object of the present invention to provide a new and improved electronic device attachment mechanism including a first attachment adapted for securement to a piece of furniture or car dashboard. A second attachment is adapted for securement to an electronic device. The second attachment is adapted for removable coupling with the first attachment.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the electronic device attachment mechanism constructed in accordance with the principles of the present invention.

FIG. 2 is a back view of the present invention.

FIG. 3 is a perspective view of the first attachment of the present invention illustrated attached to a piece of furniture.

FIG. 4 is a perspective view of the second attachment of the present invention illustrated attached to an electronic device.

FIG. 5 is a perspective view of the present invention illustrated in use.

FIG. 6 is a side view of the present invention as taken along line 6-6 of FIG. 5.

The same reference numerals refer to the same parts through the various figures.

### DESCRIPTION OF THE PREFERRED EMBODIMENT

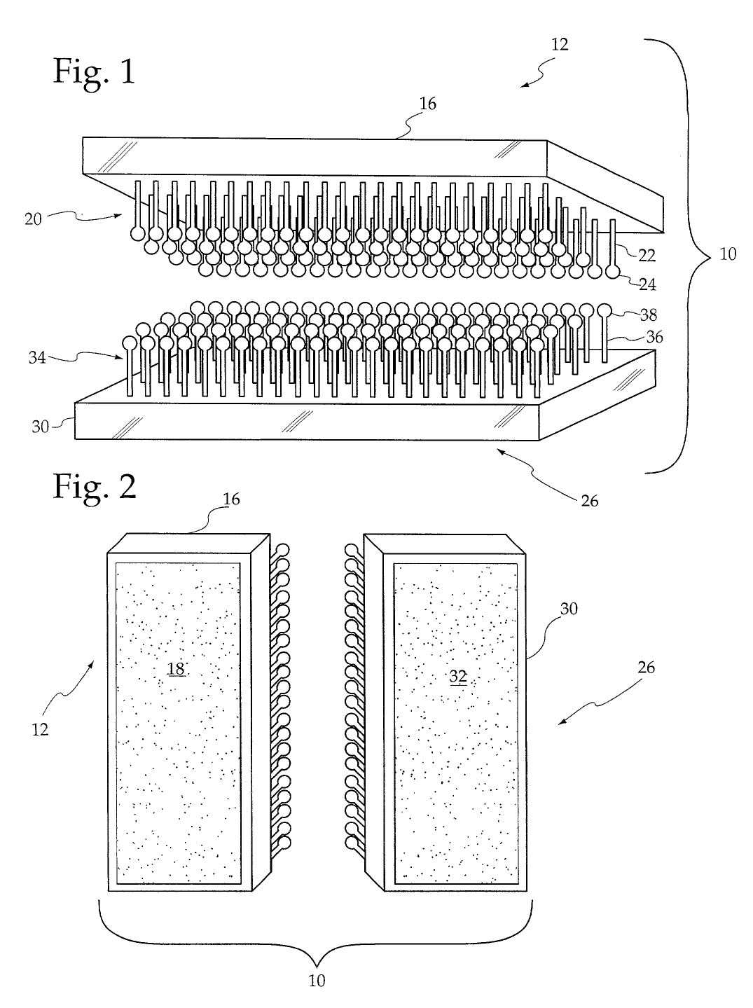

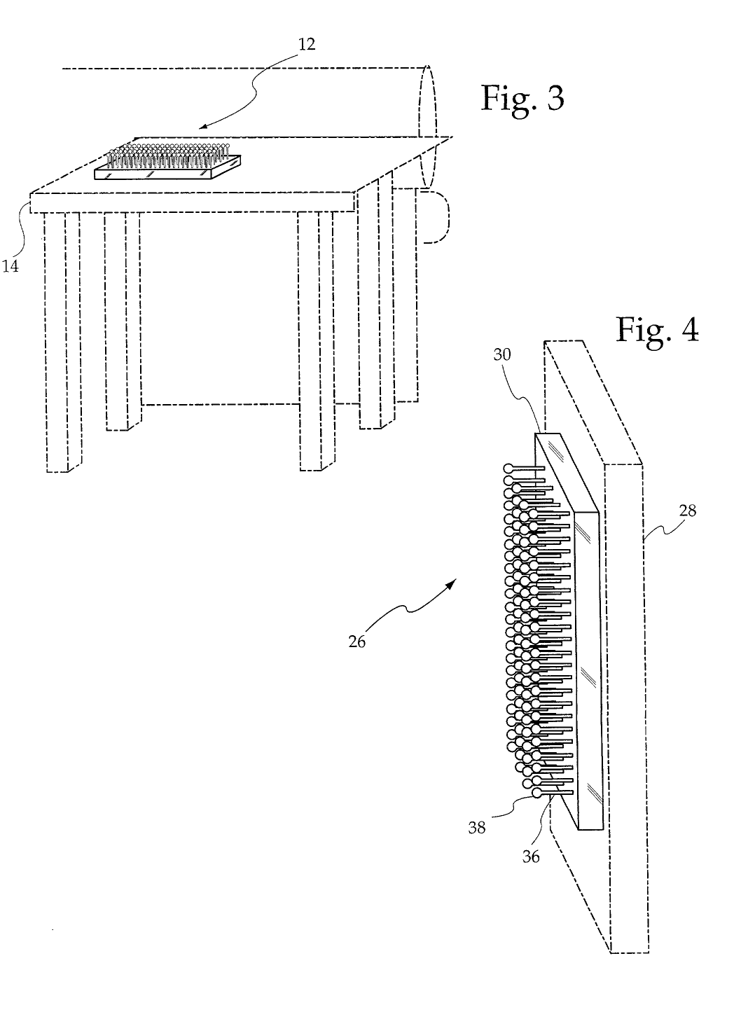

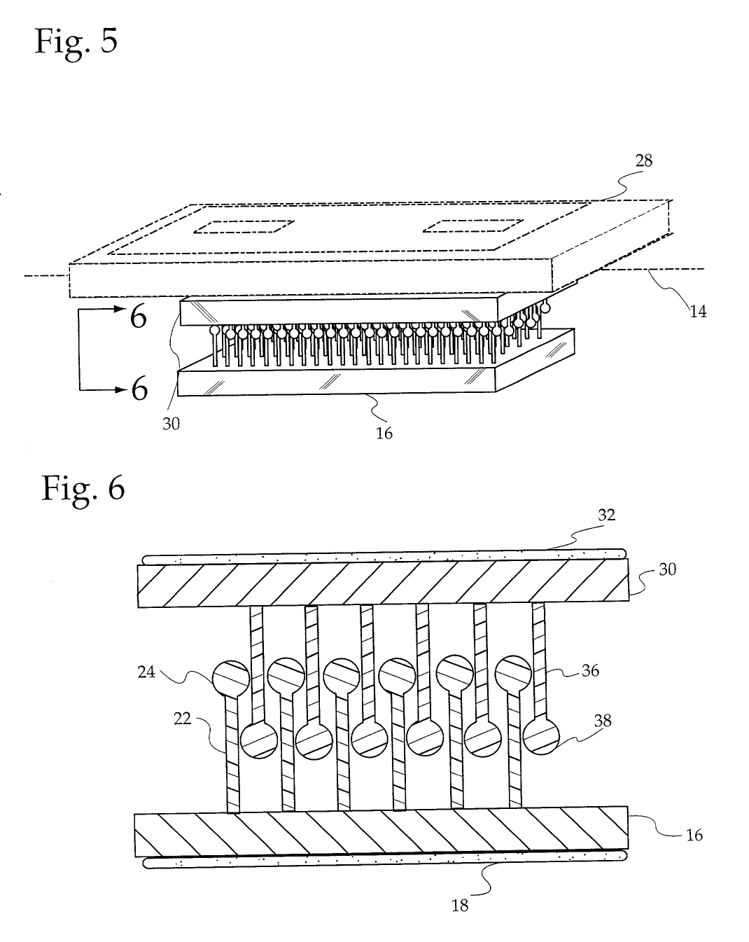

With reference now to the drawings, and in particular, to FIGS. 1 through 6 thereof, the preferred embodiment of the new and improved electronic device attachment mechanism embodying the principles and concepts of the present invention and generally designated by the reference number 10 will be described.

Specifically, it will be noted in the various figures that the device relates to an electronic device attachment mechanism for allowing an electronic device to be removably attached to a piece of furniture or car dashboard to prevent it from becoming lost. In its broadest context, the device consists of a first attachment and a second attachment. Such components are individually configured and correlated with respect to each other so as to attain the desired objective.

The first attachment 12 is adapted for securement to a piece of furniture 14 or the like. The first attachment 12 includes a generally rectangular base member 16 having an upper surface and a lower surface. The lower surface has an adhesive 18 disposed thereon for securement to the piece of furniture 14 or the like. The upper surface has a plurality of attachment bristles 20 extending outwardly therefrom. Each of the bristles 20 include an elongated stem 22 having a ball 24 secured to an outer end thereof.

The second attachment 26 is adapted for securement to an electronic device 28, such as a remote control or a cellular telephone. The second attachment 26 is adapted for removable coupling with the first attachment 12. The second attachment 26 includes a generally rectangular base member 30 having an upper surface and a lower surface. The lower surface has an adhesive 32 disposed thereon for securement to the electronic device 28. The upper surface has a plurality of attachment bristles 34 extending outwardly therefrom. Each of the bristles 34 include an elongated stem 36 having a ball 38 secured to an outer end thereof. The plurality of attachment bristles 34 of the second attachment 26 engage the plurality of bristles 20 of the first attachment 12 for removably coupling the electronic device 28 to the piece of furniture 14 or the like.

In use, the present invention will allow an electronic device 28 to be securely mounted to a piece of furniture 14 or the like when not in use. Additionally, the present invention allows the electronic device 28 to be removed from the piece of furniture 14 or the like when needed to perform its function. When the user is finished using the electronic device 28, it can be reattached to the piece of furniture 14 or the like through the use of the bristles 20,34.

As to the manner of usage and operation of the present invention, the same should be apparent from the above description.

Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the united states is as follows:

1. An electronic device attachment mechanism for allowing an electronic device to be removably attached to a piece of furniture or car dashboard to prevent it from becoming lost comprising, in combination:
a first attachment adapted for securement to a piece of furniture or a car dashboard, the first attachment including a generally rectangular base member having an upper surface and a lower surface, the lower surface having an adhesive disposed thereon for securement to the piece of furniture or car dashboard, the upper surface having a plurality of attachment bristles extending outwardly therefrom, each of the bristles including an elongated stem having a ball secured to an outer end thereof; and
a second attachment adapted for securement to an electronic device, the second attachment being adapted for removable coupling with the first attachment, the second attachment including a generally rectangular base member having an upper surface and a lower surface, the lower surface having an adhesive disposed thereon for securement to the electronic device, the upper surface having a plurality of attachment bristles extending outwardly therefrom, each of the bristles including an elongated stem having a ball secured to an outer end thereof, the plurality of attachment bristles of the second attachment engaging the plurality of bristles of the first attachment for removably coupling the electronic device to the piece of furniture or the car dashboard.

2. An electronic device attachment mechanism for allowing an electronic device to be removably attached to a piece of furniture or a car dashboard to prevent it from becoming lost comprising, in combination:
a first attachment adapted for securement to a piece of furniture or a car dashboard; and
a second attachment adapted for securement to an electronic device, the second attachment being adapted for removable coupling with the first attachment.

3. The electronic device attachment mechanism as set forth in claim 2, wherein the first attachment includes a generally rectangular base member having an upper surface and a lower surface, the lower surface having an adhesive disposed thereon for securement to the piece of furniture or the car dashboard.

4. The electronic device attachment mechanism as set forth in claim 3, wherein the second attachment includes a generally rectangular base member having an upper surface and a lower surface, the lower surface having an adhesive disposed thereon for securement to the electronic device.

5. The electronic device attachment mechanism as set forth in claim 4, wherein the upper surfaces of the first and second attachments each have a plurality of attachment bristles extending outwardly therefrom, the plurality of attachment bristles of the second attachment engaging the plurality of bristles of the first attachment for removably coupling the electronic device to the piece of furniture or car dashboard.

6. The electronic device attachment mechanism as set forth in claim 5, wherein each of the bristles of the first and second attachments include an elongated stem having a ball secured to an outer end thereof.
